(19) United States
(12) Patent Application Publication
(10) Pub. No.: US 2011/0000509 A1
(43) Pub. Date: Jan. 6, 2011

(54) PHOTORESIST TOOL CLEANING JIG CONFIGURED TO RECEIVE FLOW FROM TOP AND BOTTOM

(75) Inventors: Chin Yu Chen, Shanghai (CN); Kin Mun Choong, Shanghai (CN); Chun Chi Chen, Hsinchu (TW); Wei Zhu, Shanghai (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Semiconductor Manufacturing International (Shanghai Corporation), Shanghai (CN)

(21) Appl. No.: 12/259,152

(22) Filed: Oct. 27, 2008

(30) Foreign Application Priority Data
Jul. 4, 2008 (CN) 200810040279.1

(51) Int. Cl. B08B 9/093

(52) U.S. Cl. 134/22.18; 134/166 R

(57) ABSTRACT

A cup wash disk jig employed to clean photoresist from a spin-on chamber, receives cleaning solvent from both the bottom and the top, enhancing cleaning effectiveness. The cup wash disk includes a first set of channels allowing fluid communication between a hole positioned in a top surface of the cup wash disk jig, and a plurality of orifices distributed about the edge of the jig. Solvent is applied to the top surface of the jig, for example from an existing reduce resist control (RRC) nozzle normally utilized to dispense resist material. The solvent is flowed through these channels and ejected from the disk sides through the orifice, thereby facilitating removal of resist residue from coater cup portions of the chamber. Solvent may also be applied to an opening in a bottom surface of the jig, for example from a back rinse nozzle, to flow through a second set of channels and be ejected through different jig edge orifices.

### CROSS-REFERENCE TO RELATED APPLICATIONS

This application claims priority to Chinese Application No. 200810040279.0, filed Jul. 4, 2008, commonly assigned, and incorporated herein by reference for all purposes.

### BACKGROUND OF THE INVENTION

The present invention is directed to integrated circuits and their processing for the manufacture of semiconductor devices. More particularly, the invention provides a method and an apparatus for lithography process for the manufacture of integrated circuits. But it would be recognized that the invention has a much broader range of applicability. For example, the invention can be applied to a variety of devices such as dynamic random access memory devices, static random access memory devices (SRAM), application specific integrated circuit devices (ASIC), microprocessors and microcontrollers, Flash memory devices, and others.

Integrated circuits or “ICs” have evolved from a handful of interconnected devices fabricated on a single chip of silicon to millions of devices. Current ICs provide performance and complexity far beyond what was originally imagined. In order to achieve improvements in complexity and circuit density (i.e., the number of devices capable of being packed onto a given chip area), the size of the smallest device feature, also known as the device “geometry”, has become smaller with each generation of ICs. Semiconductor devices are now being fabricated with features less than a quarter of a micron across.

Increasing circuit density has not only improved the complexity and performance of ICs but has also provided lower cost parts to the consumer. An IC fabrication facility can cost hundreds of millions, or even billions, of dollars. Each fabrication facility will have a certain throughput of wafers, and each wafer will have a certain number of ICs on it. Therefore, by making the individual devices of an IC smaller, more devices may be fabricated on each wafer, thus increasing the output of the fabrication facility. Making devices smaller is very challenging, as each process used in IC fabrication has a limit. That is to say, a given process typically only works down to a certain feature size, and then either the process or the device layout needs to be changed.

An example of a semiconductor process that is important to make smaller and smaller devices is lithography process for the manufacture of integrated circuits. Lithography process includes steps of depositing a photoresist material, patterning and developing the photoresist material.

The deposition of a photoresist typically involves the application of liquid material to the surface of a spinning wafer. This process can result in splashing and spraying of resist material in the chamber. Such liquid droplets can lead to the contamination of other wafers placed in the chamber for the application of photoresist.

From the above, it is seen that an improved technique for processing semiconductor devices is desired.

### BRIEF SUMMARY OF THE INVENTION

The present invention is directed to integrated circuits and their processing for manufacture of semiconductor devices. More particularly, the invention provides a method and an apparatus for improving the cleanliness of processing environment and reducing defects on the integrated circuits. Merely by ways of example, the invention has been applied to a lithography process. But it would be recognized that the invention has a much broader range of applicability.

In accordance with one embodiment, a cup wash disk jig employed to clean photoresist from a spin-on coating chamber, receives cleaning solvent from both the bottom and the top, enhancing cleaning effectiveness. The cup wash disk includes a first set of channels allowing fluid communication between a hole positioned in a top surface of the cup wash disk jig, and a plurality of orifices distributed about the edge of the jig. Solvent is applied to the top surface of the jig, for example from an existing reduce resist control (RRC) nozzle normally utilized to dispense resist material. The solvent is flowed through these channels and ejected from the disk sides through the orifice, thereby facilitating removal of resist residue from coater cup portions of the chamber. Solvent may also be applied to an opening in a bottom surface of the jig, for example from a back rinse nozzle, to flow through a second set of channels and be ejected through different jig edge orifices.

Many benefits are achieved by way of the present invention over conventional techniques. For example, the present technique provides a clean environment for processing integrated circuits. In certain embodiments, the apparatus and method according to the present invention provides means to eliminate certain defects and improve device yield. Depending on the embodiments, one or more of these benefits may be achieved. These and other benefits will be described in more throughout the present specification and more particularly below.

An embodiment of an apparatus in accordance with the present invention for processing a substrate, comprises, a process chamber having a wall surrounding a rotatable support, and a cleaning jig comprising a top plate defining an opening in fluid communication with an orifice in an edge portion through a fluid channel. A nozzle is configured to spray liquid downward into the opening as the cleaning jig is rotated, such that the liquid is flowed through the channel and of the orifice, and sprayed against the wall.

An embodiment of an apparatus in accordance with the present invention for cleaning a photoresist dispensing tool, comprises, a first plate and a top plate defining an opening in fluid communication with an orifice in an edge portion through a fluid channel defined between the first plate and the top plate. The opening is configured to receive a flow of cleaning fluid from a nozzle and to direct the cleaning fluid out of the orifice against a surrounding wall.

An embodiment of a method in accordance with the present invention for cleaning a processing chamber, comprises, disposing a cleaning jig on a rotatable support within a process chamber, the cleaning jig comprising a top plate defining an opening in fluid communication with an orifice in an edge portion through a fluid channel, and rotating the support and the cleaning jig. A cleaning liquid is flowed from a nozzle downward into the opening as the cleaning jig is rotated, such that the liquid is flowed through the channel and of the orifice, and sprayed against a wall of the chamber.

Various additional objects, features and advantage of the present invention can be more fully appreciated with reference to the detailed description and accompanying drawings that follow.

### BRIEF DESCRIPTION OF THE DRAWINGS

FIG. 1A is a simplified cross-sectional view of a conventional apparatus for cleaning a photoresist spin-on chamber.

FIG. 1B is a simplified plan view of a conventional cup wash disk apparatus for use in the conventional apparatus of FIG. 1A.

FIG. 1C is a simplified cross-sectional view of the conventional cup wash disk of FIG. 1A.

FIG. 1CA is a simplified side elevational view of the conventional cup wash disk of FIG. 1C.

FIG. 2 is a simplified cross-sectional view of a conventional apparatus for dispensing fluid to the surface of a substrate.

FIG. 3AA is an electron micrograph of a surface of a substrate showing a defect arising during resist processing.

FIG. 3AB is an electron micrograph showing an enlarged view of the defect of FIG. 3AA.

FIG. 3B is an electron micrograph of a surface of a substrate showing another defect arising during resist processing.

FIG. 3C is an electron micrograph of a surface of a substrate showing still another defect arising during resist processing.

FIG. 4A is a simplified cross-sectional view of an embodiment of an apparatus in accordance with the present invention for cleaning a photoresist spin-on chamber.

FIG. 4B is a simplified cross-sectional view of the cup wash disk apparatus of FIG. 4A.

FIG. 4BA is a simplified side elevational view of the cup wash disk apparatus of FIG. 4A.

FIG. 4C is a simplified plan view of an embodiment of the cup wash disk apparatus for use in the apparatus of FIG. 4A.

FIG. 5 compares the time consumed by recipe steps for a conventional process versus the time consumed by an embodiment of a process in accordance with the present invention.

### DETAILED DESCRIPTION OF THE INVENTION

According to the present invention, techniques for processing a substrate are provided. More particularly, the invention provides a method and an apparatus for improving the cleanliness of processing environment and reducing defects on the integrated circuits. Merely by ways of example, the invention has been applied to a lithography process. But it would be recognized that the invention has a much broader range of applicability.

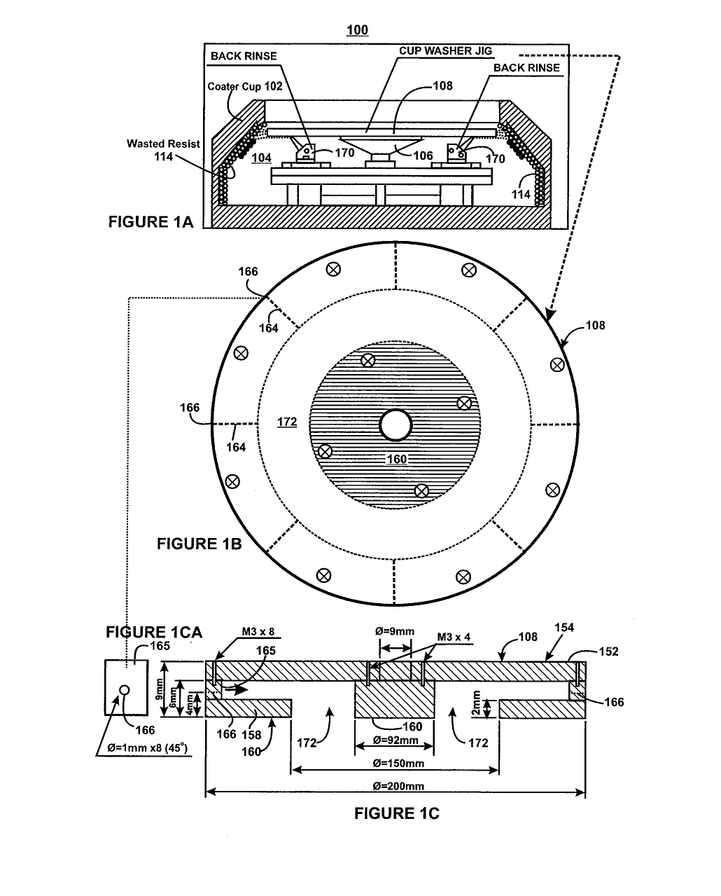

FIG. 1A is a simplified cross-sectional view of a conventional apparatus for cleaning a photoresist spin-on chamber. Apparatus 100 comprises coater cup 102 surrounding edges of chamber 104 housing substrate support 106. Substrate support 106 is configured to rotatably support either a substrate, or a cup wash disk jig 108 having dimensions similar to a substrate, within the chamber 104.

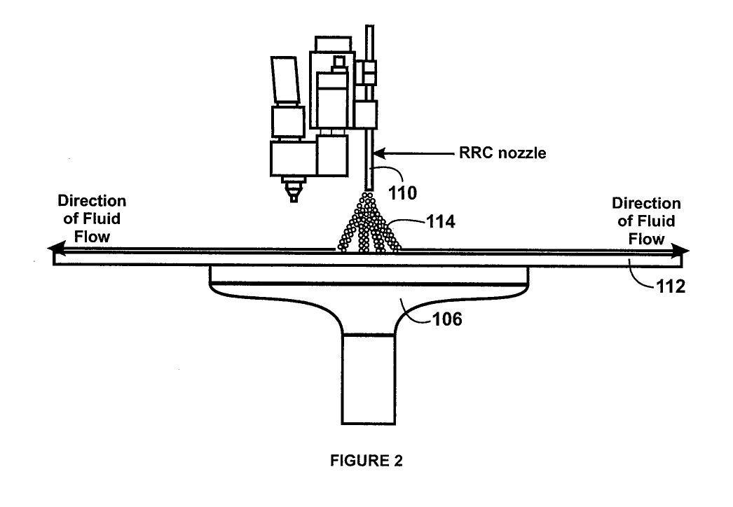

When a substrate or workpiece is positioned on the rotatable support such as a spin chuck within the coating chamber, a vacuum is applied through the support to fix the workpiece to the support, and then both the substrate and the support are spun while liquid photoresist is applied from an overlying reduce resist control (RRC) nozzle to the center of the spun substrate or workpiece. FIG. 2 is a simplified cross-sectional view of a conventional apparatus for dispensing fluid 114 to the surface of a substrate, showing RRC nozzle 110, substrate 112, and support 106.

As a result of rotation of the substrate supported within the chamber, the liquid photoresist is distributed at an even thickness over the surface of the substrate, with excess photoresist being ejected from the substrate sides. Coater cup 102 receives and stops this splashed excess resist material, much of which flows downward to the bottom of the chamber for collection.

However, some of the excess photoresist dries on the sides of the coater cup 102, remaining as residue in the chamber. This dried photoresist can contaminate other wafers that are subsequently placed into the chamber to receive photoresist.

The dried photoresist residue present on the interior surfaces of the coater cup can be removed by the application of solvent. Accordingly, FIG. 1B is a simplified plan view of a conventional cup wash disk apparatus for use in the conventional apparatus of FIG. 1A. FIG. 1C is a simplified cross-sectional view of a conventional apparatus for cleaning a photoresist spin-on chamber. FIG. 1CA is a simplified side elevational view of the conventional apparatus of FIG. 1C.

Cup wash test jig 108 of FIGS. 1B-CA comprises an upper plate 152 defining upper surface 154, edge 156, and lower plate 158 defining lower surface 160, secured with a plurality of bolts 162 and enclosing a plurality of channels 164 that are in fluid communication with orifices 166 in edge 165. In operation, cup wash jig 108 is inserted into the chamber such that lower surface 160 is in contact with support 106. Support 106 and cup wash jig 108 is then rotated within the chamber, while solvent from back rinse nozzles 170 positioned at the bottom of the chamber, spray solvent into opening 172 in the underside of the cup wash jig 108. The force of the spinning cup wash jig 108 causes the liquid to flow through channels 164 and be forcefully ejected through edge orifices 166 against the inside surfaces of coater cup 102, thereby leading to the removal of residue therefrom.

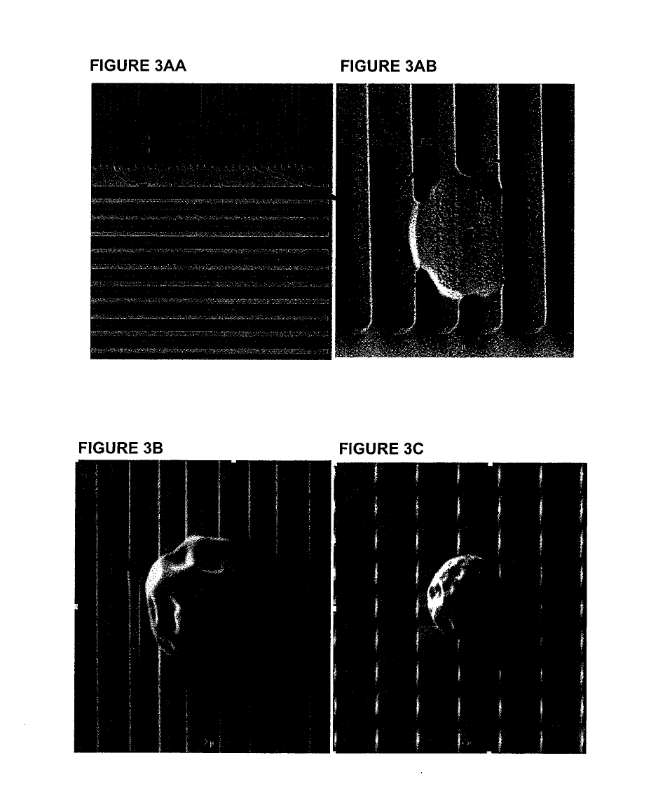

The conventional cup washing jig apparatus shown in FIGS. 1A-1CA is effective to remove residue remaining from spun photoresist. However, some such residue may remain and contribute to the formation of defects on a processed substrate. For example, FIG. 3AA is an electron micrograph of a surface of a substrate showing a defect arising during resist processing. FIG. 3AB is an electron micrograph showing an enlarged view of the defect of FIG. 3AA.

FIGS. 3B-C are electron micrographs showing “ball type” defects present on the surface of a surface. These “ball type” defects may result from the clumping or aggregation of excess resist material not fully removed by the previous application of solvent through the conventional cup disk wash jig apparatus. Such clumped or aggregated resist material can deleteriously affect subsequent photoresist development steps.

In order to more effectively remove unwanted residue from the chamber of a resist processing tool, embodiments in accordance with the present invention relate to a cup wash disk jig configured to receive cleaning solvent from both the bottom and the top, thereby enhancing cleaning effectiveness. The cup wash disk includes a first set of channels allowing fluid communication between a hole positioned in a top surface of the cup wash disk jig, and a plurality of orifices distributed about the edge of the jig. Solvent applied to the top surface of the jig, for example from an existing reduce resist control (RRC) nozzle of the tool, is flowed through these channels and ejected from the disk sides through the orifice, thereby facilitating removal of resist residue from coater cup portions of the chamber. Solvent may also be applied to an opening in a bottom surface of the jig, for example from a back rinse nozzle, to flow through a second set of channels and be ejected through different jig edge orifices.

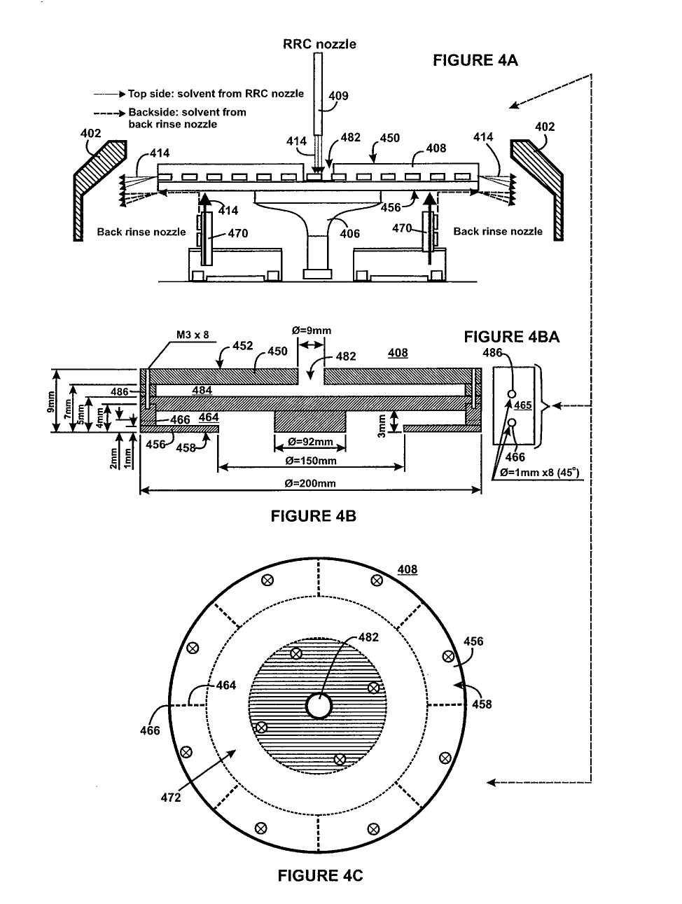

FIG. 4A is a simplified cross-sectional view of an embodiment of an apparatus in accordance with the present invention for cleaning a photoresist spin-on chamber. FIG. 4B is a simplified cross-sectional view of the cup wash disk jig apparatus of FIG. 4A. FIG. 4C is a simplified elevational view of the edge of the cup wash disk jig apparatus of FIG. 4B. FIG. 4C is a simplified plan view of the cup wash disk jig apparatus of FIGS. 4A-BA.

Resist processing apparatus 400 comprises chamber 404 having surrounding walls comprising coater cup element 402, and housing substrate support 406. Substrate support 406 is configured to rotatably support either a substrate, or a cup wash disk jig 408 having dimensions similar to a substrate, within the chamber 400. When a substrate is positioned on the support within the chamber, the support and substrate are spun while liquid photoresist is applied from an overlying reduce resist control (RRC) nozzle 409 to the center of the spun substrate.

Alternatively, a cup wash test jig 408 in accordance with an embodiment of the present invention may be positioned within the chamber upon rotatable support 406. Cup wash jig 408 comprises upper plate 450 having surface 452, edge member 454, and lower plate 456 having surface 458, secured together by bolts or screws. Like the conventional cup wash jig 108 of FIGS. 1A-C, cup wash jig 408 in accordance with the present invention comprises a first plurality of channels 464 that are in fluid communication with an opening 472 in lower surface 458 and with orifices 466 in edge 465. Unlike the conventional cup wash jig 108, however, cup wash jig 408 accordance with embodiments of the present invention also comprises a second plurality of channels 480 that are in fluid communication with opening 482 in top plate 450 and a second (upper) set of orifices 486 in edge 465 of the cup wash test jig.

In operation, cup wash jig 408 is inserted into the chamber such that lower surface 458 is in contact with support 406. Support 406 and cup wash jig 408 are then rotated within the chamber, while solvent from back rinse nozzles 470 positioned at the bottom of the chamber, spray solvent into opening 472 in the underside of the cup wash jig. The force of the spinning cup wash jig causes the solvent to flow through channels 464 and be forcefully ejected through edge orifices 466 against the inside surfaces of coater cup 402, thereby leading to the removal of residue therefrom.

Simultaneously, RRC nozzle 409 positioned in the top of the chamber sprays solvent into opening 482 defined in the top surface of the cup wash jig. The force of the spinning cup wash jig also causes the solvent to flow through the second channels 480 and be forcefully ejected through second edge orifices 486 against the inside surfaces of the coater cup, thereby enhancing exposure of the coater cup elements and any residue present thereon, to solvent.

Embodiments of methods and apparatuses in accordance with the present invention offer a number of benefits over conventional techniques. One important advantage is ease of adaptability to current systems. As described above, conventional processing systems commonly employ an RRC nozzle configured to spray liquid photoresist material downward onto the surface of a wafer. Merely by configuring this RRC nozzle to selectively receive photoresist removal solvent instead of liquid photoresist, the improved cleaning jig is readily utilized with existing photoresist dispensing systems.

Another advantage offered by embodiments in accordance with the present invention is enhanced cleaning effectiveness. Specifically, as the coater cup element is simultaneously exposed to solvent spray from two different orifices of the spinning wash disk jig, any residue present thereon will be removed more thoroughly.

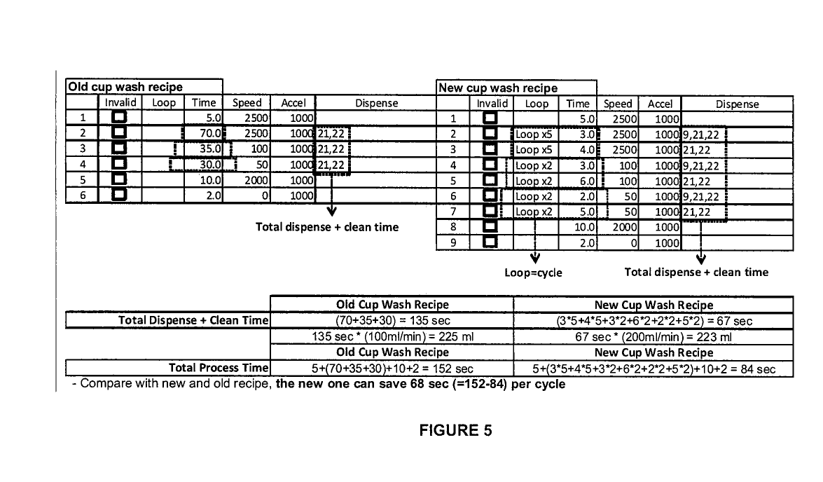

Another important advantage offered by embodiments in accordance with the present invention is more rapid cleaning, and hence higher throughput. For example, FIG. 5 compares the time consumed by recipe steps for a conventional process versus the time consumed by an embodiment of a process in accordance with the present invention, where equivalent cleaning is achieved. FIG. 5 shows a reduction in process time of 68 seconds utilizing an embodiment in accordance with the present invention.

Although the above has been illustrated according to a specific embodiment, there can be other modifications, alternatives, and variations. For example, while the above embodiments has been described in connection with cleaning a chamber configured to apply photoresist to a spinning substrate, the present invention is not limited to this particular application. In accordance with alternative embodiments, the present invention could be employed in connection with other than resist processing in which liquid is applied to surface of a spinning substrate.

Moreover, while the above embodiment has been described as preventing contamination during the fabrication of semiconductor devices on a substrate, embodiments in accordance with the present invention are not limited to this particular application. In accordance with alternative embodiments, the fabrication of other than semiconductor substrates, including but not limited to magnetic hard disk materials, optical hard disk materials such as are used for DVDs, CDs, and CD-ROMs, and flat panels comprising glass or other insulating materials.

It is also understood the embodiments and examples described herein are for illustrative purposes only and that various modifications or changes in light thereof will be suggested to person skilled in the art and are to be included with the spirit and purview of this application and scope of the appended claims.

What is claimed is:

1. An apparatus for processing a substrate, the apparatus comprising:
a process chamber having a wall surrounding a rotatable support;
a cleaning jig comprising a top plate defining an opening in fluid communication with an orifice in an edge portion through a fluid channel; and
a nozzle configured to spray liquid downward into the opening as the cleaning jig is rotated, such that the liquid is flowed through the channel and of the orifice, and sprayed against the wall.

2. The apparatus of claim 1 wherein the nozzle is selectively configured to flow the liquid comprising one of photoresist and a solvent for removing photoresist.

3. The apparatus of claim 1 wherein the cleaning jig is in the shape of one of a semiconductor wafer, a magnetic recording medium, an optical recording medium, and a flat panel display.

4. The apparatus of claim 3 wherein the cleaning jig is in the shape of a semiconductor wafer having a diameter of about 200 mm.

5. The apparatus of claim 1 wherein the cleaning jig further comprises a bottom plate defining a second opening in fluid communication with a second orifice in an edge portion through a second fluid channel, a middle plate separating the first fluid channel from the second fluid channel, the apparatus further comprising a back rinse nozzle configured to spray the liquid into the second opening.

6. The apparatus of claim 1 wherein the nozzle is selectively configured to flow the liquid comprising a solvent for removing photoresist.

7. The apparatus of claim 1 wherein the bottom plate defines the second opening around a lower surface configured to be in contact with the support.

8. An apparatus for cleaning a photoresist dispensing tool, the apparatus comprising:
a first plate; and
a top plate defining an opening in fluid communication with an orifice in an edge portion through a fluid channel defined between the first plate and the top plate, the opening configured to receive a flow of cleaning fluid from a nozzle and to direct the cleaning fluid out of the orifice against a surrounding wall.

9. The apparatus of claim 8 having a shape of one of a semiconductor wafer, a magnetic recording medium, an optical recording medium, and a flat panel display.

10. The apparatus of claim 8 having a shape of a semiconductor wafer with a diameter of about 200 mm.

11. The apparatus of claim 8 further comprising a bottom plate defining a second opening in fluid communication with a second orifice in an edge portion through a second fluid channel, the first plate separating the first fluid channel from the second fluid channel, the second opening configured to receive a second flow of a cleaning fluid from a back rinse nozzle and to direct the cleaning fluid out of the second orifice against the surrounding wall.

12. The apparatus of claim 11 wherein the bottom plate defines the second opening around a lower surface configured to be in contact with the support.

13. A method for cleaning a processing chamber, the method comprising:
disposing a cleaning jig on a rotatable support of within a process chamber, the cleaning jig comprising a top plate defining an opening in fluid communication with an orifice in an edge portion through a fluid channel;
rotating the support and the cleaning jig; and
flowing a cleaning liquid from a nozzle downward into the opening as the cleaning jig is rotated, such that the liquid is flowed through the channel and of the orifice, and sprayed against a wall of the chamber.

14. The method of claim 13 further comprising selectively configuring the nozzle to flow the cleaning liquid instead of liquid photoresist material.

15. The method of claim 13 wherein the cleaning jig is in the shape of one of a semiconductor wafer, a magnetic recording medium, an optical recording medium, and a flat panel display.

16. The method of claim 13 wherein the cleaning jig is in the shape of a semiconductor wafer having a diameter of about 200 mm.

17. The method of claim 13 further wherein the cleaning jig further comprises a bottom plate defining a second opening in fluid communication with a second orifice in an edge portion through a second fluid channel, a middle plate separating the first fluid channel from the second fluid channel, the method further comprising also flowing the cleaning liquid to the second opening from a back rinse nozzle.

18. The method of claim 13 wherein the bottom plate defines the second opening around a lower surface configured to be in contact with the rotatable support.
